(19) United States
(12) Patent Application Publication
(10) Pub. No.: US 2007/0241558 A1
(43) Pub. Date: Oct. 18, 2007

(54) PROTECTIVE COVER SYSTEM AND METHOD FOR GIRTH-WELDS

(75) Inventors: Mark K. Nestegard, Mendota Heights, MN (US); Mark T. Anderson, Woodbury, MN (US); Dawn V. Muyres, Austin, TX (US); Mario A. Perez, Burnsville, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/697,987

(22) Filed: Apr. 9, 2007

Related U.S. Application Data
(60) Provisional application No. 60/744,961, filed on Apr. 17, 2006.

(51) Int. Cl. F16L 47/00

(52) U.S. Cl. 285/294.2; 285/294.3; 285/294.1

(57) ABSTRACT

A pipe system includes first and second pipes having first and second ends welded together forming a girth-weld and a corrosion coating covering the girth-weld. In addition, a flexible sheet is provided to cover the girth-weld. The flexible sheet comprises a first structured layer that mechanically couples to the corrosion coating, where the corrosion coating permeates a substantial portion of the first structured layer. The flexible sheet also includes a second layer comprising a polymer layer adhered to the first layer, the second layer protecting the corrosion coating from mechanical or environmental damage. Alternatively, the protective cover comprises a polymer material and includes a port formed therethrough adapted to receive a delivery mechanism that delivers a corrosion coating to the girth-weld.

### CROSS-REFERENCE TO RELATED APPLICATION

This application claims the benefit of U.S. Provisional Patent Application No. 60/744,961, filed Apr. 17, 2006, the disclosure of which is incorporated by reference herein in its entirety.

### FIELD OF THE INVENTION

The present invention relates to a protective girth-weld cover system and method. More specifically, the present invention relates to a protective cover or sheet that protects a girth-weld without having to utilize an external heat source.

### BACKGROUND

In the oil and gas industry, transmission pipelines are laid to transport a variety of liquids and gases. These pipelines are formed of many miles of steel piping that can vary from 8 to 80 inches in diameter. Depending on the location and environmental conditions, the pipe may be installed above ground or buried. The exterior of the pipe can be in contact with highly corrosive environments, such as seawater, soil, rock, air, or other gases, liquids or solids.

To protect the pipes from stresses due to exposure from often extreme environmental conditions, the pipe exteriors are generally coated with a protective coating in the factory, not the site where the pipes are to be installed. Conventional protective coatings are described in J. A. Kehr, “Fusion-Bonded Epoxy (FBE): A Foundation for Pipeline Corrosion Protection”, NACE Press (Houston, Tex.), 2003 (see e.g., Chapter 4 and pages 234-246). For example, a three layer protective coating, that includes a fusion bonded epoxy, an adhesive, and a polyolefin topcoat, is typically applied to pipe in the factory.

However, the pipe ends are not coated, with about 6 inches (axial length) of uncoated pipe at each end, where pipe segments are welded together. The resulting welds are referred to as “girth-welds” or “field joints” and are not coated with a protective coating before the installation is complete.

As such, girth-welds can be susceptible to corrosion and other environmental effects. Several methods to protect the girth-weld are known. The most frequently used and accepted method is utilizing a protective cover, such as a heat shrink sleeve, to cover the girth-weld. However, conventionally installed heat shrink sleeves tend to provide diminished protection prior to the end of the expected service lifetime as the sleeves are susceptible to moving away from the weld, thereby leaving the joint unprotected. Moreover, the use of a torch to shrink the protective sleeve is not only dangerous, but is also highly skill dependent, meaning that a completely and uniformly shrunk protective cover is not ensured under all circumstances.

Other approaches (and their problems) are described in J. A. Kehr, “Fusion-Bonded Epoxy (FBE): A Foundation for Pipeline Corrosion Protection”, NACE Press (Houston, Tex.), 2003 (see e.g., Chapter 7).

### SUMMARY

In one aspect, a pipe system includes first and second pipes having first and second ends welded together forming a girth-weld and a corrosion coating covering the girth-weld. In addition, a flexible sheet is provided to cover the girth-weld. The flexible sheet comprises a first structured layer that mechanically couples to the corrosion coating, where the corrosion coating permeates a substantial portion of the first structured layer. The flexible sheet also includes a second layer comprising a polymer layer adhered to the first layer, the second layer protecting the corrosion coating from damage, such as mechanical or environmental damage.

In another aspect, a pipe system includes first and second pipes having first and second ends welded together forming a girth-weld and a protective cover to surround the girth-weld, the cover comprising a polymer material and having a port formed therethrough adapted to receive a delivery mechanism that delivers a corrosion coating to the girth-weld.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

FIGS. 1A-1C are schematic views of a girth-weld and of a flexible sheet with a structured surface covering the girth-weld according to an aspect of the present invention.

FIG. 2 is a schematic view of flexible sheet with a structured surface according to an aspect of the present invention.

FIG. 3 is a schematic view of an alternative protective cover system according to another aspect of the present invention.

These figures are not drawn to scale and are intended only for illustrative purposes. While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

Aspects of the present invention relate to a protective cover for girth-welds. After the girth-weld is formed (and optionally cleaned), a corrosion (protection) coating is applied in the field to the girth-weld. Before the corrosion coating cures or sets, a protective cover is then disposed over the girth-weld. In one aspect, the protective cover is a multilayer material having a first structured layer that mechanically couples to a corrosion coating coated thereon, where the corrosion coating permeates a substantial portion of the first structured layer. The multilayer cover material also includes a second layer comprising a polymer layer adhered to the first layer, where the second layer protects the corrosion coating and girth-weld from damage.

In an alternative aspect, after the girth-weld is formed, a protective cover is disposed over the girth-weld. This protective cover includes an injection system that provides for the corrosion coating to be applied to the girth-weld after the protective cover is positioned and disposed over the girth-weld. In a preferred aspect, as the corrosion coating is being injected onto the girth-weld area through the protective coating, excess coating can flow through bleed holes formed in the protective coating to provide an indication of completion of the installation process.

Further, in both the alternative aspects, full installation of the protective cover system can be accomplished without the need for an external heat source. More details are provided below.

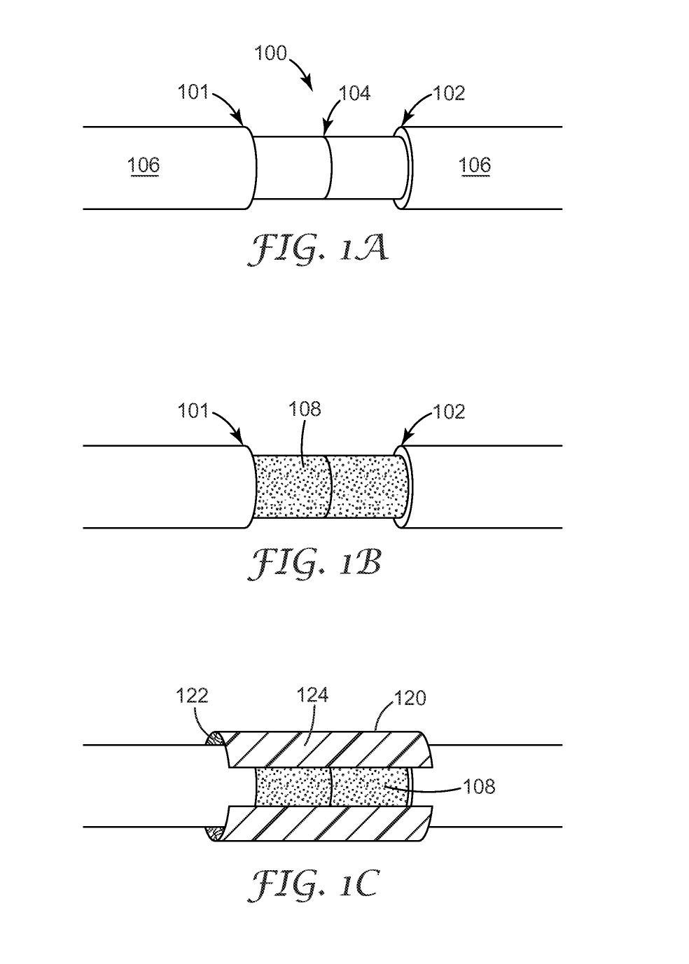

A first aspect of the present invention is shown in FIGS. 1A-1C, a pipeline 100 having a girth-weld 104 with a flexible protective cover or sheet 120. In this exemplary embodiment, girth-weld 104 joins pipe ends 101 and 102 and can be protected by exemplary flexible protective cover or sheet 120, which preferably surrounds the entire girth-weld.

Pipe ends 101, 102 can be formed from a standard pipe material, such as steel. Pipe ends 101, 102 also include an outer coating 106 that can comprise a conventional protective coating, such as a polyolefin-based coating. In an exemplary embodiment, protective coating 106 comprises a three-layer coating having an epoxy, an adhesive and a polyolefin top coat that are melt-fused together on the pipe ends 101, 102. As would be understood by one of ordinary skill in the art given the present description, other formulations of protective coatings, such as two-layer coatings, and those described in J. A. Kehr, “Fusion-Bonded Epoxy (FBE): A Foundation for Pipeline Corrosion Protection”, NACE Press (Houston, Tex.), 2003 (see e.g., Chapter 4 and pages 234-246) (incorporated by reference herein), can also be utilized as the protective coat 106.

As is also shown in FIG. 1A, in an exemplary embodiment, portions of the pipe coating 106, e.g., about 2 to 10 inches in length from the pipe ends, can be removed, stripped, or sanded off to help promote better welding in the field.

As shown in FIG. 1B, the girth-weld 104 can be coated with a corrosion (prevention) coating 108 after the welding operation (and also after an optional cleaning process to remove excess particles from the pipe end surfaces). An exemplary corrosion coating 108 comprises an epoxy or urethane material. For example, the corrosion coating 108 can be a two-part liquid system or liquid epoxy (such as Scotchcast 323 available from 3M Company, St. Paul, Minn.).

As shown in FIG. 1C and in FIG. 2, the flexible protective cover or sheet 120 is a multilayer structure having first and second layers 122, 124. For example, first layer (or inner surface) 122 can be formed from a woven fabric material, a knitted fabric material, or a non-woven material. Preferably, layer 122 is textured and/or includes a plurality of structures (e.g., small structures often referred to as microstructures, such as protruding fibers or a polymer mesh with microstructured hooks) that can mechanically couple to the corrosion coating 108. Also, preferably, the first layer 122 interacts with the corrosion coating 108 such that the corrosion coating permeates the first (structured) layer.

In addition, flexible protective cover or sheet 120 can include a second layer (or outer surface) 124 that provides impact protection for the girth-weld 104. For example, layer 124 can comprise a polymer material (e.g., polypropylene or polyethylene) having suitable toughness. Layer 124 can be bonded or adhered to layer 122 in a conventional manner (e.g., lamination).

In operation, a girth-weld is formed in the field by joining pipe ends 101 and 102. After welding, optionally, the girth-weld area can be further cleaned. Additionally, a field-applied corrosion coating 108 can be applied to the girth-weld.

After the corrosion coating 108 is applied and/or partially cured, the flexible protective cover or sheet 120 is disposed (e.g., wrapped) over the girth-weld 104. Optionally, the sheet 120 is provided in roll form and the adjoining wrap ends or edges can be coupled or sealed together using a mechanical fastener. Preferably, the sheet 120 is wrapped about the girth-weld such that the inner surface of the sheet 120 contacts a substantial amount of the newly applied or partially cured corrosion coating 108.

As mentioned above, in an exemplary embodiment, an inner surface of the flexible protective cover or sheet 120 is structured (e.g., with hooks or fibers), thus providing for a mechanical bonding with the corrosion coating 108 as it further cures, to anchor the sheet 120 into the underlying corrosion coating. In addition, as the corrosion coating is not yet fully cured, in a preferred aspect, as the flexible sheet is wrapped around the girth-weld, a substantial portion of the first layer is permeated by the corrosion coating, thus allowing the flexible cover 120 to better bond to the surface of the girth-weld region. The flexible protective cover or sheet 120 does not require the use of an external heat source (e.g., a hot air gun or a propane torch) to create a bond between the protective sheet and the girth-weld region of the pipeline or system.

Thus, in this aspect, a no-heat weld wrap can be utilized as an alternative to a heat shrink sleeve. The sheet's mechanical structures can anchor the sheet into the underlying corrosion coating to help prevent the sheet 120 from slipping under soil stresses.

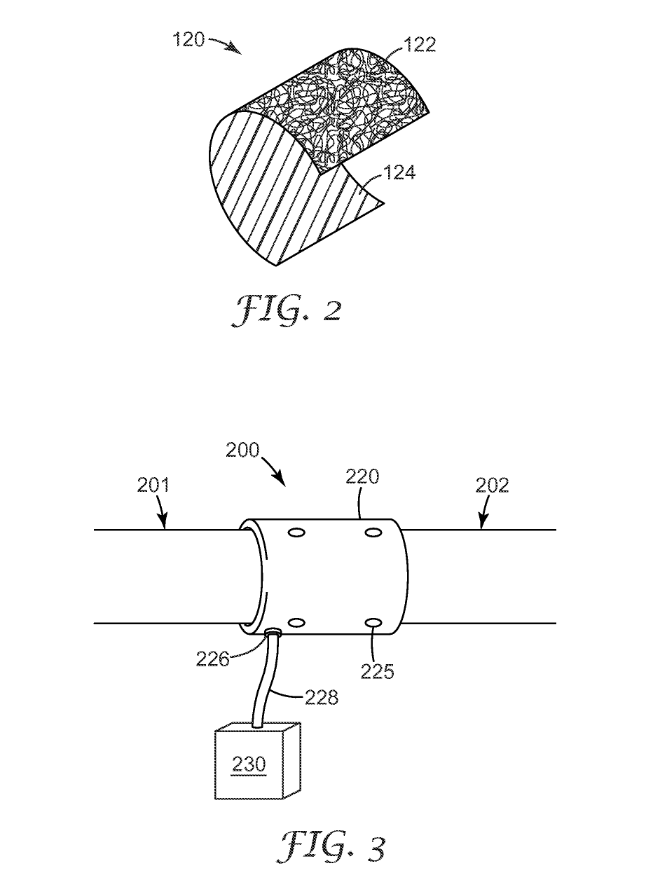

An alternative aspect of the present invention is shown in FIG. 3. Here, a pipeline 200 has a girth-weld (not shown) that joins pipe ends 201 and 202. A protective cover or sheet 220 is provided to surround and protect the girth-weld. Preferably, the protective cover or sheet can be formed from a flexible material. Unlike the previous embodiment, in this alternative aspect, a corrosion coating, preferably a liquid corrosion coating, is applied to the girth-weld after the protective cover 220 is disposed in place surrounding the girth-weld.

As shown in FIG. 3, protective cover 220 includes an injection system to provide a corrosion coating to the girth-weld. In this exemplary embodiment, the injection system includes a container 230 (that optionally includes a pump mechanism (e.g., a syringe or electric liquid pump)) and a delivery tube 228, which is coupled to the protective cover 220 via a port or inlet 226, to deliver the corrosion coating to the girth-weld. For example, the corrosion coating can be a two-part liquid system or liquid epoxy (such as Scotchcast 323 available from 3M Company, St. Paul, Minn.). The corrosion coating can cover the girth-weld, the bare steel that is formed about the girth-weld, and a portion of the mainline coating.

In addition, cover 220 can further include one or more bleed holes 225 formed therethrough. The holes 225 can be formed in cover 220 through a standard technique, such as a mechanical process (e.g., drilling, puncturing, etc.), focused radiation (e.g., laser, or other), or thermal process.

In one aspect, protective cover 220 comprises a flexible polymer (such as a polyolefin material) sheet that is secured in place around the girth-weld via, e.g., a mechanical fastener, an adhesive, and/or a clamp. Alternatively, the protective cover 220 can comprise a more ridged polymer that has been shaped or molded to fit around the weld. In another aspect, the protective cover 220 is formed from a substantially transparent material.

In operation, a protective cover 220 is placed around the girth-weld. The cover 220 can then be secured down to the mainline pipe coating via a clamp, a fastener, or the like. A liquid corrosion coating is then delivered to the girth-weld area or the pipe. Preferably, the corrosion coating is injected through port 226 at the (relative) bottom of the cover 220 to completely fill the space between the pipe and the wrap. As the space enclosed by cover 220 is filled with the corrosion coating, air is pushed out of the system. When full, the corrosion coating may begin to seep out of the bleed holes 225, indicating completion. In preferred aspects, the corrosion coating has a color different from the color of the protective cover, thus providing a more visual indication of completion of the process as the corrosion coating may begin to seep out of the bleed holes 225 or as the installer sees the corrosion coating (through a substantially transparent cover) spreading over the girth-weld region.

As with the embodiment of FIGS. 1C and 2, this alternative aspect does not require the use of an external heating device. In addition, the air bleed system can reduce the likelihood of voids forming between the cover and the coated pipe. Moreover, there is a reduced exposure to the corrosion coating and a reduced likelihood of issues caused by “open drying.”

Further, corrosion coating and protective cover 220 can be provided to an installer as a kit that could include the protective cover, a pre-measured bag or other container of liquid corrosion coating, (optionally) a pump, and a hose that could attach to port 226.

While the present invention has been described with a reference to exemplary preferred embodiments, the invention may be embodied in other specific forms without departing from the scope of the invention. Accordingly, it should be understood that the embodiments described and illustrated herein are only exemplary and should not be considered as limiting the scope of the present invention. Other variations and modifications may be made in accordance with the scope of the present invention.

It is claimed:

1. A pipe system, comprising:
first and second pipes having first and second ends welded together forming a girth-weld;
a corrosion coating covering the girth-weld; and
a flexible sheet covering the girth-weld, the sheet comprising a first structured layer that mechanically couples to the corrosion coating, wherein the corrosion coating permeates a substantial portion of the first structured layer, and a second layer comprising a polymer layer adhered to the first layer, the second layer protecting the corrosion coating from damage.

2. The pipe system of claim 1, wherein the first layer comprises a woven fabric material.

3. The pipe system of claim 1, wherein the first layer comprises a non-woven material.

4. The pipe system of claim 1, wherein the first layer comprises a surface having micro structures.

5. The pipe system of claim 1, wherein the first layer comprises a knitted fabric material.

6. A pipe system, comprising:
first and second pipes having first and second ends welded together forming a girth-weld; and
a protective cover to surround the girth-weld, the cover comprising a polymer material and having a port formed therethrough adapted to receive a delivery mechanism that delivers a corrosion coating to the girth-weld.

7. The pipe system of claim 6, wherein the delivery system comprises a container that at least temporarily holds an amount of a corrosion coating and a tube coupling the container to the port formed in the protective cover.

8. The pipe system of claim 7, wherein the delivery system further comprises a pump to transfer the corrosion coating from the contained to the port.

9. The pipe system of claim 7, wherein the corrosion coating comprises a liquid epoxy material.

10. The pipe system of claim 6, wherein the protective cover further comprises one or more bleed holes formed therethrough.

11. The pipe system of claim 6, wherein the protective cover is substantially transparent.

12. The pipe system of claim 6, wherein the corrosion coating comprises a different color than a color of the protective cover.

13. A method of forming a protected girth-weld, comprising:
welding first and second pipe ends together to form the girth-weld;
coating the girth-weld with a corrosion coating; and
prior to a full curing of the corrosion coating, disposing a flexible sheet covering the girth-weld, the sheet comprising a first structured layer that mechanically couples to the corrosion coating, wherein the corrosion coating permeates a substantial portion of the first structured layer, and a second layer comprising a polymer layer adhered to the first layer, the second layer protecting the corrosion coating from damage.

14. The method of claim 13, further comprising cleaning the girth-weld prior to the coating step.

15. A method of forming a protected girth-weld, comprising:
welding first and second pipe ends together to form the girth-weld;
disposing a protective cover to surround the girth-weld, the protective cover comprising a polymer material and having a port formed therethrough adapted to receive a delivery mechanism that delivers a corrosion coating to the girth-weld; and
delivering an amount of a corrosion coating to the girth-weld via the delivery mechanism, wherein the amount is an amount sufficient to cover the girth-weld.

16. The method of claim 15, further comprising cleaning the girth-weld prior to the disposing step.

17. The method of claim 15, further comprising providing a visual indication of a completion of the delivering step.

18. The method of claim 17, wherein the corrosion coating comprises a different color than a color of the protective cover.
